(19) United States
(12) Patent Application Publication
(10) Pub. No.: US 2026/0109539 A1
(43) Pub. Date: Apr. 23, 2026

(54) GARBAGE BIN WITH ASYMMETRICAL DUAL-OPENING LID

(71) Applicant: ZHEJIANG ERHUI TECHNOLOGY CO., LTD., Taizhou (CN)

(72) Inventor: Ting ZHOU, Taizhou (CN)

(73) Assignee: ZHEJIANG ERHUI TECHNOLOGY CO., LTD., Taizhou (CN)

(21) Appl. No.: 19/420,616

(22) Filed: Dec. 15, 2025

Related U.S. Application Data
(63) Continuation of application No. PCT/CN2024/104363, filed on Jul. 9, 2024.

(30) Foreign Application Priority Data
Feb. 21, 2024 (CN) 202420326084.7

(51) Int. Cl. B65F 1/16

(52) U.S. Cl. CPC B65F 1/1623

(57) ABSTRACT

A garbage bin with an asymmetrical dual-opening lid. The garbage bin comprises a bin body (1), an upper base body is provided at an upper end of the bin body, a waste disposal opening having a rectangular shape is arranged on the upper base body, and a lid-opening structure is provided at the garbage disposal opening (11). The lid-opening structure comprises a bin lid (2) having a shape that matches that of the garbage disposal opening (11), and a driving device and a transmission mechanism for driving the bin lid (2) to flip. The bin lid (2) comprises a front flip plate (21) and a rear flip plate (22), and the front and rear flip plates are of an asymmetrical structure in width, the width of the front flip plate (21) being less than that of the rear flip plate (22).

### CROSS-REFERENCE TO RELATED APPLICATIONS

This application is a continuation of International Patent Application No. PCT/CN2024/104363 with an international filing date of Jul. 9, 2024, which claims priority to Chinese Patent Application No. 202420326084.7 filed on Feb. 21, 2024.

### TECHNICAL FIELD

The present disclosure relates to a garbage bin, in particular, to a garbage bin with an asymmetrical dual-opening lid.

### BACKGROUND

For example, Utility Model Publication No. CN217893965U discloses a dual-lid structure for a garbage bin. The garbage bin comprises a bin body having a waste disposal opening at its upper end, with a lid-opening structure arranged at the waste disposal opening. The lid-opening structure includes two symmetrically arranged plate-shaped flip lids, a drive device, and a transmission mechanism. The combined shape of the two flip lids matches the shape of the waste disposal opening. Rotational connecting portions are symmetrically arranged at both ends in the length direction of each flip lid, and the flip lids are pivotally connected to the inner side of the waste disposal opening through the rotational connecting portions. The drive device and transmission mechanism are disposed inside the garbage bin, with the drive device driving the flip lids to rotate via the transmission mechanism. By adopting the dual-lid form, the flip lids open to both sides and sink downward into the waste disposal opening, with the lid edges either being fully accommodated within the waste disposal opening or slightly protruding above it. The dual-lid structure can enlarge the size of the waste disposal opening, achieve faster opening speed, and prevent the flip lids from hitting the user's hand during garbage disposal.

However, it has been found that, since the flip lids adopt a sinking structure, they occupy the internal space of the bin body. In order to prevent garbage from contacting the flip lids and to ensure their normal opening and closing, the storage capacity for garbage inside the bin body is reduced. The applicant further discovered that, as long as the front flip lid sinks downward to avoid hitting the user's hand, the rear flip lid protruding above the waste disposal opening is more convenient for garbage disposal.

### SUMMARY

### Technical Problems

The present disclosure provides a garbage bin with an asymmetrical dual-opening lid. The front and rear flip plates adopt an asymmetrical width structure, with the width of the front flip plate smaller than that of the rear flip plate. When the lid is opened, the front flip plate is entirely accommodated within the waste disposal opening or with only its edge slightly protruding above the opening, while the edge of the rear flip plate protrudes above the waste disposal opening. By reducing the width of the front flip plate, the present disclosure reduces the occupation of the bin's internal capacity when the plate sinks inward. Meanwhile, by increasing the width of the rear flip plate, it serves as a baffle at the rear side of the waste disposal opening, thereby facilitating the disposal of garbage into the bin.

### Technical Proposals

To achieve the above objectives, the following technical proposals are adopted:

A garbage bin with an asymmetrical dual-opening lid includes a bin body. An upper base body is arranged at an upper end of the bin body, a waste disposal opening having a rectangular shape is arranged on the upper base body, and a lid-opening structure is arranged at the waste disposal opening. The lid-opening structure includes a bin lid matching the shape of the waste disposal opening, and a drive device and a transmission mechanism for driving the bin lid to flip. The bin lid includes a front flip plate and a rear flip plate, a width of the rear flip plate being greater than a width of the front flip plate. Rotational connecting portions extending downwardly are arranged on a bottom part of the front flip plate at both ends in a length direction thereof, or at positions near both ends in the length direction thereof, and lower parts of the rotational connecting portions are pivotally connected to an inner side of the waste disposal opening. The drive device and the transmission mechanism drive the front flip plate to open or close via the rotational connecting portions. When the front flip plate is opened, it can sink inward to be accommodated within the waste disposal opening, with all edges of the front flip plate accommodated within the waste disposal opening, and the rear flip plate, when opened, is higher than the waste disposal opening and serves as a baffle.

Rotational connecting portions extending downwardly are also arranged on a bottom part of the rear flip plate at both ends in a length direction thereof, or at positions near both ends in the length direction thereof, and the rotational connecting portions are connected to the rear flip plate near a rear side of the rear flip plate. Lower parts of the rotational connecting portions are pivotally connected to the inner side of the waste disposal opening.

The rotational connecting portions are perpendicular to the front flip plate and the rear flip plate.

A length of the bin lid is greater than a width thereof.

The width of the front flip plate matches a height of the upper base body.

A width ratio of the rear flip plate to the front flip plate is greater than 2.

### Advantageous Effects

The present disclosure designs the bin lid as a front flip plate and a rear flip plate in an asymmetrical arrangement. The front flip plate is relatively narrow in width, so that when opened it can be entirely accommodated within the waste disposal opening without occupying the internal space of the bin body, and without striking the user's hand during garbage disposal. The rear flip plate, when opened, is higher than the waste disposal opening and serves as a baffle. In this way, the present disclosure not only overcomes the problems of slow lid-opening speed and a relatively small waste disposal opening found in existing single-flip-plate garbage bins, but also resolves the problem of internal space occupation in existing sinking-type dual-opening lids.

### BRIEF DESCRIPTION OF THE DRAWINGS

FIG. 1 is a schematic structural diagram of the present disclosure;

FIG. 2 is a schematic structural diagram of the present disclosure with the bin lid opened;

FIG. 3 is a first schematic structural diagram of the bin lid of the present disclosure;

FIG. 4 is a second schematic structural diagram of the bin lid of the present disclosure; and

FIG. 5 is a schematic structural diagram of the bin body of the present disclosure.

### DETAILED DESCRIPTION OF EMBODIMENTS

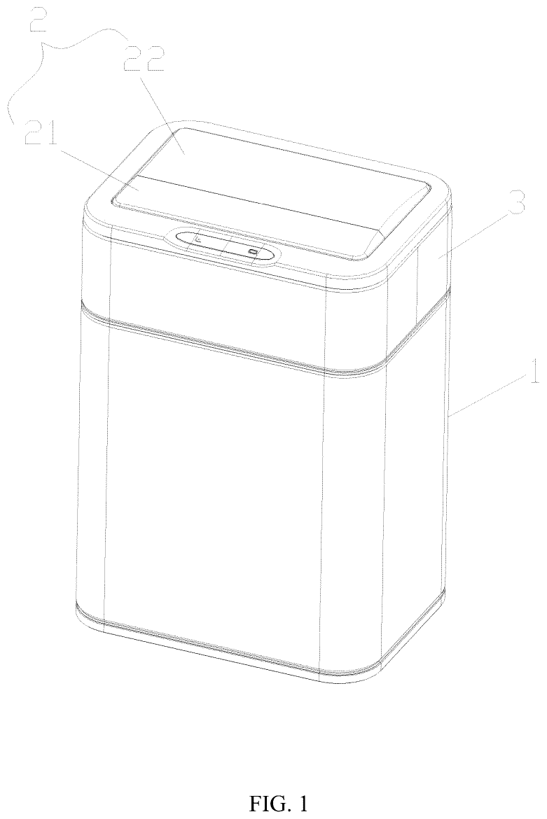

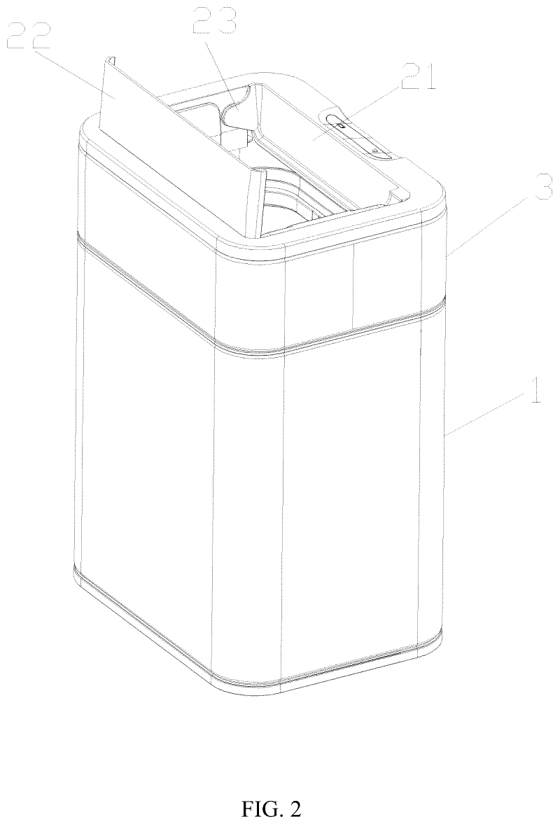

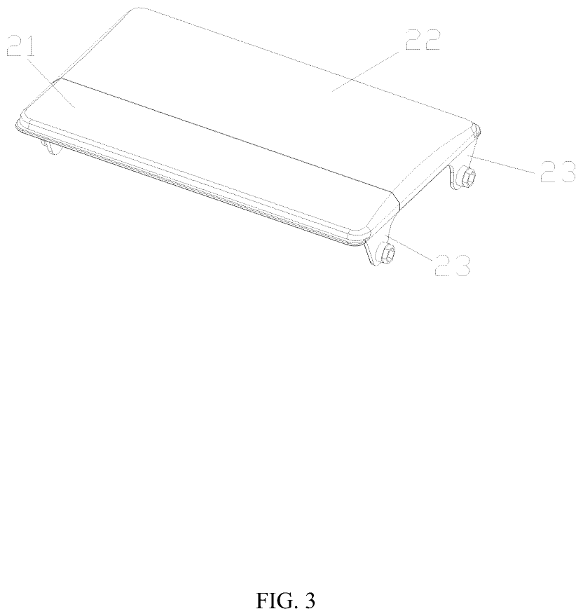

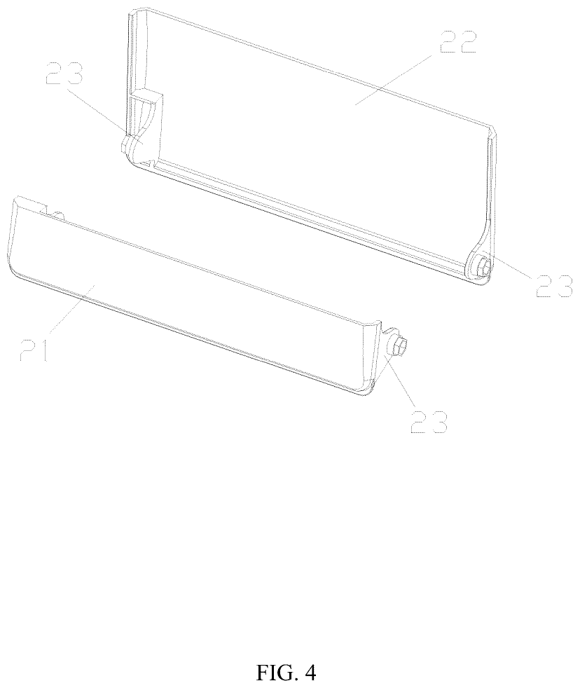

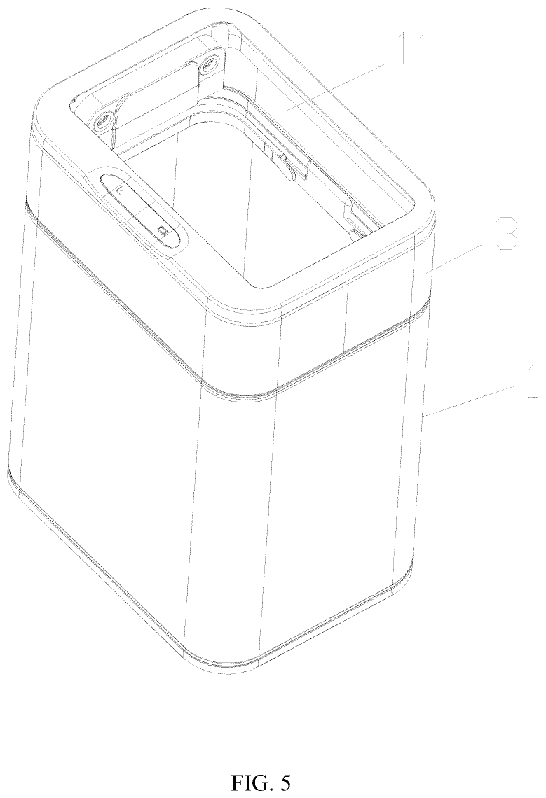

As shown in FIGS. 1 to 5, a garbage bin with an asymmetrical dual-opening lid includes a bin body 1. An upper base body 3 is provided at an upper end of the bin body 1, and a waste disposal opening 11 is arranged on the upper base body 3. The waste disposal opening 11 has a rectangular structure, and a lid-opening structure is provided at the waste disposal opening 11. The lid-opening structure includes a bin lid 2, which matches the shape of the waste disposal opening, as well as a drive device and a transmission mechanism for driving the bin lid to flip. A length of the bin lid 2 is greater than its width. The bin lid 2 includes a front flip plate 21 and a rear flip plate 22, a width of the rear flip plate 22 being greater than that of the front flip plate 21, and the width of the front flip plate matching a height of the upper base body. Rotational connecting portions 23 extending downwardly are arranged on a bottom part of the front flip plate 21 at both ends in the length direction thereof, or at positions near both ends in the length direction thereof, and lower parts of the rotational connecting portions 23 are pivotally connected to an inner side of the waste disposal opening 11. The rotational connecting portions 23 extending downwardly are further arranged on a bottom part of the rear flip plate 22 at both ends in the length direction thereof, or at positions near both ends in the length direction thereof, and the upper parts of the rotational connecting portions 23 are connected to the rear flip plate 22 near its rear side. The lower parts of these rotational connecting portions 23 are pivotally connected to the inner side of the waste disposal opening. The rotational connecting portions 23 are perpendicular to the front flip plate 21 and the rear flip plate 22. The drive device and the transmission mechanism drive the front and rear flip plates to open or close synchronously. When the front flip plate 21 is opened, it can sink inward to be accommodated within the waste disposal opening 11, with either all edges of the front flip plate 21 accommodated within the waste disposal opening 11 or only a rear edge slightly protruding above the waste disposal opening 11.

In this embodiment, the waste disposal opening adopts a rectangular structure, and the length of the bin lid is greater than its width. In addition, an asymmetrical width design is adopted for the rear and front flip plates, so that the front flip plate is narrower and can match the height of the upper base body. In this way, when the front flip plate is opened, it does not occupy the internal space of the bin body, and the entire front flip plate can sink inward into the waste disposal opening. The rear flip plate, when opened, protrudes above the waste disposal opening and serves as a baffle. This design not only overcomes the problems of slow lid-opening speed and a relatively small waste disposal opening in existing single-flip-plate garbage bins, but also solves the issues in dual-opening lids where the flip lids may strike the user's hand during garbage disposal and where sinking-type dual-opening lids occupy internal bin space.

In this embodiment, a rectangular waste disposal opening is adopted. However, the bin lid of the present disclosure is not limited to a rectangular structure. Any implementation employing an asymmetrical dual-flip-plate structure, in which the front flip plate sinks into the waste disposal opening without occupying or minimally occupying the internal space of the bin body, and the rear flip plate protrudes above the waste disposal opening, shall fall within the protection scope of the present disclosure.

What is claimed is:

1. A garbage bin with an asymmetrical dual-opening lid, comprising a bin body (1), wherein an upper base body is arranged at an upper end of the bin body (1), a waste disposal opening (11) having a rectangular shape is arranged on the upper base body, and a lid-opening structure is arranged at the waste disposal opening (11), the lid-opening structure comprises a bin lid (2) matching a shape of the waste disposal opening and a drive device and a transmission mechanism for flipping the bin lid (2), the bin lid (2) comprises a front flip plate (21) and a rear flip plate (22), a width of the rear flip plate (22) is greater than a width of the front flip plate (21); rotational connecting portions (23) extending downwardly are arranged on a bottom part of the front flip plate (21) at both ends in a length direction thereof, or at positions near both ends in the length direction thereof, lower parts of the rotational connecting portions (23) are pivotally connected to an inner side of the waste disposal opening (11); when the front flip plate (21) is opened, it can sink inward to be accommodated within the waste disposal opening (11), with all edges of the front flip plate (21) accommodated within the waste disposal opening (11), and the rear flip plate (22), when opened, is higher than the waste disposal opening (11) and serves as a baffle.

2. The garbage bin with an asymmetrical dual-opening lid according to claim 1, wherein the rotational connecting portions (23) extending downwardly are further arranged on a bottom part of the rear flip plate (22) at both ends in a length direction thereof, or at positions near both ends in the length direction thereof, upper parts of the rotational connecting portions (23) are connected to the rear flip plate (22) near a rear side thereof, and the lower parts of the rotational connecting portions (23) are pivotally connected to the inner side of the waste disposal opening.

3. The garbage bin with an asymmetrical dual-opening lid according to claim 2, wherein the rotational connecting portions (23) are perpendicular to the front flip plate (21) and the rear flip plate (22).

4. The garbage bin with an asymmetrical dual-opening lid according to claim 1, wherein a length of the bin lid is greater than a width thereof.

5. The garbage bin with an asymmetrical dual-opening lid according to claim 4, wherein a width ratio of the rear flip plate to the front flip plate is greater than 2.

6. The garbage bin with an asymmetrical dual-opening lid according to claim 4, wherein the width of the front flip plate matches a height of the upper base body.
